(19) United States
(12) Patent Application Publication
(10) Pub. No.: US 2008/0313291 A1
(43) Pub. Date: Dec. 18, 2008

(54) METHOD AND APPARATUS FOR ENCODING DATA

(75) Inventor: Syed Zafar Kazmi, San Diego, CA (US)

Correspondence Address: SCHWEGMAN, LUNDBERG & WOESSNER, P.A., P.O. BOX 2938, MINNEAPOLIS, MN, 55402, US

(73) Assignee: SmartMicros USA, LLC, San Diego, CA (US)

(21) Appl. No.: 12/138,252

(22) Filed: Jun. 12, 2008

Related U.S. Application Data
(60) Provisional application No. 60/943,446, filed on Jun. 12, 2007.

(51) Int. Cl. G06F 17/00; G06F 15/16

(52) U.S. Cl. 709/206; 709/246; 709/204

(57) ABSTRACT

Methods and apparatuses for encoding data are described. In one embodiment, source data may be received. A control character may be inserted in the source data as a delimiter to create delimited data. The delimited data may be provided over a network.

### CROSS-REFERENCE TO A RELATED APPLICATION

This application claims the benefit of U.S. Provisional Patent Application entitled “A Method and Apparatus for Encoding Data”, Ser. No. 60/943,446, filed 12 Jun. 2007, the entire contents of which are herein incorporated by reference.

### BACKGROUND

Computer programs may use various standardized data formats including extensible Markup Language (XML), JavaScript Object Notation (JSON), and Abstract Syntax Notation One (ASN.1) to encode or serialize application specific data for later use by the same or another computer program. These applications may have various characteristics including flexibility, extensibility, memory size requirements, computer processing requirement, and human readability. Data encoding formats are designed to optimize on one or more of these characteristics. Text based data encoding is human readable and therefore provides an easy way for humans to work with the data. However this usually is done at the cost of increased memory and processor requirements. Typically, methods that allow for more structured organization of code tend to sacrifice compactness, as extraneous data or data overhead is introduced to format information. For example, with XML, tags are inserted to organize data into a hierarchical format, for example:

| | |
|---|---|
| a. | <weather> |
| | 1502<temperature> |
| | 150363 |
| | 1504</temperature> |
| | 1505<sky> |
| | 1506cloudy |
| | 1507</sky> |
| b. | </weather> |

In the above example, the weather data includes an element for temperature and sky. The data is organized in a hierarchical format and can be processed by an application. While XML tags may allow for an unlimited amount of hierarchical levels, the result is increased data overhead. In a number of applications and scenarios, overall size of data may be a factor in selecting a particular data encoding method. A reduced size may allow the data to be transferred faster and utilize less processing power.

Other methods for organizing data, such as JSON, may insert single characters instead of tags, for example:

| | |
|---|---|
| a. | weather |
| | { |
| | temperature : 63 , |
| | sky : cloudy |
| | } |

In the above example, the same weather data is formatted, with less data overhead. Although the data is simplified, the characters use for separating data ‘{’, ‘:’, and ‘,’, may utilize additional processing by an application, because they may also appear in the data being stored.

Delimitation is a method by which an application on a device or computer system partitions and organizes data. The result is data that is concatenated and formatted to be efficiently accepted by the application. Delimitation typically involves insertion of characters that act as separators in the data; common characters include commas, spaces, and tabs. As in the XML example described above, delimitation is accomplished with tags (e.g., “<temperature>.”) The use of delimiter characters that regularly appear in text has the disadvantage of being possibly confused by an application. This “collision” of data and delimiter may result in inaccurate data when it is later decoded.

### BRIEF DESCRIPTION OF THE DRAWINGS

Some embodiments are illustrated by way of example and not limitation in the figures of the accompanying drawings in which:

FIG. 1 is a block diagram of a system, according to an example embodiment;

FIG. 2 is a block diagram of an example data delimitation subsystem that may be deployed within the system of FIG. 1 according to an example embodiment;

FIG. 3 is a block diagram of an example data appending subsystem that may be deployed within the system of FIG. 1 according to an example embodiment;

FIG. 4 is a block diagram of an example data receiver subsystem that may be deployed within the system of FIG. 1 according to an example embodiment;

FIG. 5 is a block diagram of an example data providing subsystem that may be deployed within the system of FIG. 1 according to an example embodiment;

FIG. 6 is an example flowchart illustrating a method for delimited data providing according to example embodiments;

FIG. 7 is a block diagram of an example element according to an example embodiment;

FIG. 8 is a block diagram of an example object according to an example embodiment;

FIG. 9 is a block diagram of an example message according to an example embodiment;

FIG. 10 example table of characters according to an example embodiment;

FIG. 11 example table of delimiters according to an example embodiment;

FIG. 12 example table of data type codes according to an example embodiment;

FIG. 13 example table of data dimensions according to an example embodiment;

FIG. 14 is an example flowchart illustrating a method for data appending according to example embodiments;

FIG. 15 is a block diagram of an example enveloper according to an example embodiment;

FIG. 16 is an example flowchart illustrating a method for data receiving according to example embodiments;

FIG. 17 is a block diagram of an example element definition file according to an example embodiment;

FIG. 18 is a block diagram of an example object definition file according to an example embodiment;

FIG. 19 is a block diagram of an example request definition file and response definition file according to an example embodiment;

FIG. 20 is a block diagram of an example request and response according to an example embodiment;

FIG. 21 is an example flowchart illustrating a method for data providing according to example embodiments;

FIG. 22 is a block diagram of example components according to an example embodiment;

FIG. 23 is a block diagram of example flow logic according to an example embodiment; and

FIG. 24 is a block diagram diagrammatic representation of machine in the example form of a computer system within which a set of instructions for causing the machine to perform any one or more of the methodologies discussed herein may be executed.

### DETAILED DESCRIPTION

Example methods and apparatuses for encoding data are described. In the following description, for purposes of explanation, numerous specific details are set forth in order to provide a thorough understanding of example embodiments. It will be evident, however, to one skilled in the art that embodiments of the present invention may be practiced without these specific details.

In an example embodiment, source data may be received. A control character may be inserted in the source data as a delimiter to create delimited data.

The delimited data may be provided over a network.

In an example embodiment, a message may be generated from accessed text. Binary data may be appended to the message as an attachment. The message appended with the binary data may be provided over a network to a recipient.

In an example embodiment, transmission data including a data type identifier may be received. A data definition file defining a data format for the transmission data based on the data type identifier may be accessed. A plurality of elements of the transmission data may be identified based on the data definition file. Source data may be reconstructed based on the identifying of the plurality of elements and the data definition file.

In an example embodiment, source data in a data format may be accessed. Formatting data may be removed from the source data based on a data definition file defining the data format to create transmission data. The transmission data may be provided to a target. The target may be capable of using the data definition file to reconstruct the source data.

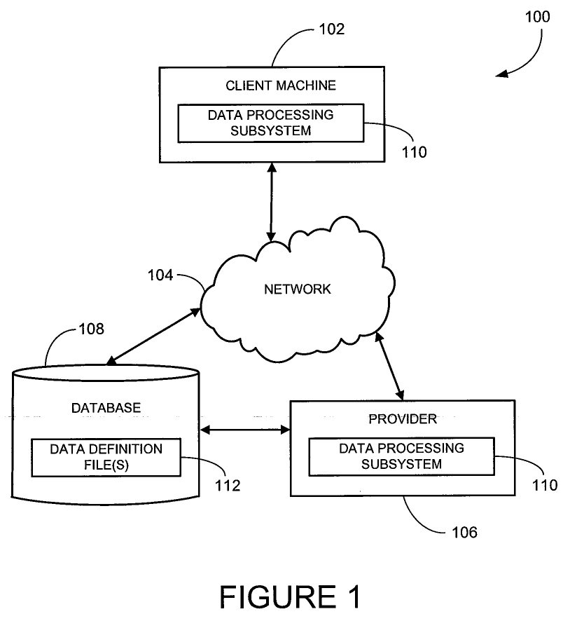

FIG. 1 illustrates an example system 100 in which a client machine 102 may be in communication with a provider 106 over a network 104. A user may operate the client machine 102 to send and/or receive data from the provider 106. Examples of the client machine 102 include a set-top box (STB), a receiver card, a mobile telephone, a personal digital assistant (PDA), a display device, a portable gaming unit, and a computing system; however other devices may also be used.

The network 104 over which the client machine 102 and the provider 106 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

The provider 106 may send data to a user and/or receive data from a user. For example, a request may be received from the client machine 102 and the provider 106 may send a response based on the receipt of the request.

A data processing subsystem 110 may be deployed within the client machine 102 and/or the provider 106 to provide delimited data over the network 104, provide a message appended with the binary data over the network 104, reconstruct source data based on identification of elements and a data definition file 112, and/or provide transmission data.

The provider 106 may also be in communication with a database 108. The database 108 may include one or more data definition files 112. The data definition file 112 may be used assist in the interpretation of data. For example, the data definition file 112 may define a data format for transmission data based on a data type identifier. The use of the data definition file 112 may, in an example embodiment, enable a reduction in overhead.

Application level data over the network 104 can take many forms and can be used in an infinite number of scenarios, for example “Customer orders”, “Weather Reports”, “Invoices”, “Health Survey”, etc. Encoded data contains informational tags to make it possible for data interpretation. For example the temperature value may be described as temperature: 65 to indicate the temperature of 65 degrees. These additional tags allow processing of the data as intended by the sender. However these tags also add overhead to the encoded data stream. This is especially true of data that is encoded and represents information that is continually being updated. As the information is updated, the same interpreting tags are transferred with each successive update. Because certain devices (e.g., mobile devices) have limited connectivity and bandwidth, the additional data may represent an inefficient manner of providing information. To address the inefficiency of resending interpreting data, an example embodiment may use the data definition file 112. The data definition file 112 may be an independent amount of data retained by the client machine 102 and/or the provider 106 to inform on how to interpret incoming successive data. Therefore, the provider 106 would only send updating data without interpreting tags. Additionally, by using the data definition files 112, information from different providers (e.g., servers and/or service providers) may standardize the method in which they provide data. By standardizing the data, interpreting information need not be provided from each of the providers 106. For example, information on weather conditions may be encoded into data from several sources worldwide. The weather information may come from different providers 106. However, if each of the providers 106 format the information to be interpreted by the data definition file 112, additional interpreting data need not be transferred with the information. As a result the total amount of information transferred to the client machine is reduced.

The data definition file 112 may be an independent file sent by the provider 106 to the client machine 102. The data definition file 112 creates a platform by which data from different sources may be formatted. By formatting data in conformance with the data definition file 112, the sources may avoid transmitting additional interpreting tags. The data definition file 112 may set a standard for interpreting groups of informational data.

The data definition file 112 may be used to define the contents of a message provided over the network 104 between the client machine 102 and the provider 106. The contents of the data definition file 112 may contain information which defines each element of the message in the order they would appear in the message. The data definition file 112 may defines the element name, its data type, its dimensions, length, or the like. In addition the data definition file 112 may contain definition of any object used in the message.

The data definition file may be available on both the client machine 102 and/or the provider 106. In an example embodiment, the data definition file 112 for message types used may be embedded within an application, (e.g. in an exe, dll, or jar file).

The data definition file 112 may also be available as a resource file in the file path or at an internet location identified by a unique URL. In an example embodiment, the client machine 102 and the provider 106 may communicate which data definition file 112 is used in a message by adding an entry in the message header. When the data definition file 112 is used, only relevant data values may be transferred without the use of any value identifiers. The recipient may then easily interpret the received data stream and construct a meaningful representation of that data using the data definition file 112 for that message. The use of the data definition file 112 may reduce the data overhead further and improve network and storage capacity.

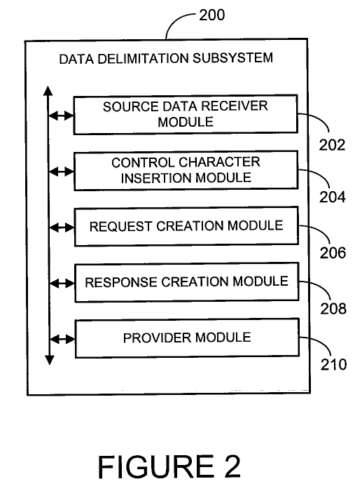

FIG. 2 illustrates an example data delimitation subsystem 200 that may be deployed as the data processing subsystem 110 in the client machine 102 and/or the provider 106 of the system 100 (see FIG. 1) or otherwise deployed in another system. The data delimitation subsystem 200 may include a source data receiver module 202, a control character insertion module 204, a request creation module 206, a response creation module 208, and/or a provider module 210. Other modules may also be included.

The source data receiver module 202 receives source data. The source data may be received from a user, from the client machine 102, and/or the provider 106. The source data may be otherwise received.

The control character insertion module 204 inserts a control character in the source data as a delimiter to create delimited data. The control character may be a nonprinting ASCII character, a single control character, multiple control characters, a character not used in normal language processing, or the like. The delimiter may include a value delimiter, a dimension separator, an element delimiter, and/or an object delimiter. Other delimiters may also be used. The delimiter may be a separator or an indicator. The delimiter may represent dimensions in the source data. The delimited data may, in an example embodiment, include delimited text.

The request creation module 206 creates a request using the delimited data. The response creation module 208 creates a response using the delimited data. The provider module 210 provides the delimited data over the network 104. The delimited data may be provided in a request, in a response, or otherwise provided. The delimited data may be provided to the client machine 102 or the provider 106.

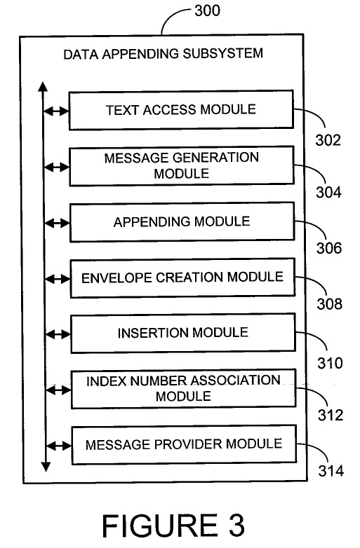

FIG. 3 illustrates an example data appending subsystem 300 that may be deployed as the data processing subsystem 110 in the client machine 102 and/or the provider 106 of the system 100 (see FIG. 1) or otherwise deployed in another system. The data appending subsystem 300 may include a text access module 302, a message generation module 304, an appending module 306, an envelope creation module 308, an insertion module 310, an index number association module 312, and/or a message provider module 314. Other modules may also be included.

The text access module 302 accesses text for a message and/or additional text for an additional message. The message generation module 304 generates a message for the accessed text and/or an additional message for the additional text.

The appending module 306 appends binary data to the message as an attachment and/or additional binary data to the additional message. The binary data (or the additional binary data) may include, by way of example, a digital image, a video clip, application specific data, or the like.

The envelope creation module 308 creates an envelope including a message appended with the binary data and an additional message appended with additional binary data.

The insertion module 310 inserts a data size delimiter within the message (and/or the additional message) to indicate a data size of the binary data, inserts an attachment number within the message to indicate a number of the attachments appended to the message, inserts a binary indicator within the message to indicate a presence of the binary data within the message, and/or inserts a message size delimiter within the message to indicate a message size of the message.

The index number association module 312 associates an index number with the binary indicator to indicate a number of the attachment relative to an additional attachment. For example, multiple attachments may be attached to a single message.

The message provider module 314 provides the message appended with the binary data and/or an additional message appended with the additional binary data over the network 104 to a recipient (e.g., the client machine 102 and/or the provider 106). The message may be provided in a data stream over the network 104 to the recipient or may be otherwise provided. The message appended with the binary data and the additional message appended with the additional binary data may be provided in a single series (e.g., in a batch) through the network 104 to the recipient or may be otherwise provided.

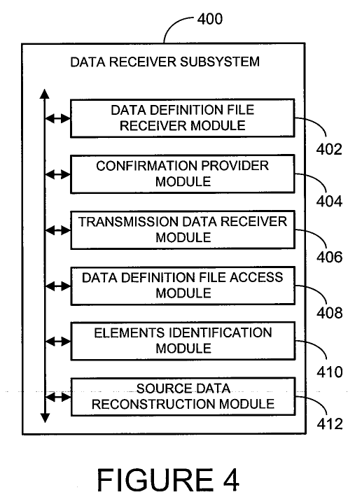

FIG. 4 illustrates an example data receiver subsystem 400 that may be deployed as the data processing subsystem 110 in the client machine 102 and/or the provider 106 of the system 100 (see FIG. 1) or otherwise deployed in another system. The data receiver subsystem 400 may include a data definition file receiver module 402, a confirmation provider module 404, a transmission data receiver module 406, a data definition file access module 408, an elements identification module 410, and/or a source data reconstruction module 412. Other modules may also be included.

The data definition file receiver module 402 receives the data definition file 112. The data definition file 112 may be received from the client machine 102, the provider 106, or may be otherwise received.

The confirmation provider module 404 provides a conformation of receipt of the data definition file 112. The transmission data receiver module 406 receives transmission data including a data type identifier. The transmission data may include tagless transmission data or other types of transmission data.

The data definition file access module 408 accesses the data definition file 112 defining a data format for the transmission data based on the data type identifier. The elements identification module 410 identifies elements of the transmission data based on the data definition file 112.

The source data reconstruction module 412 reconstructs source data based on identification of the elements and the data definition file 112.

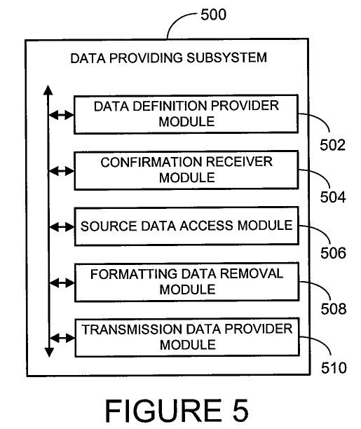

FIG. 5 illustrates an example data providing subsystem 500 that may be deployed as the data processing subsystem 110 in the client machine 102 and/or the provider 106 of the system 100 (see FIG. 1) or otherwise deployed in another system. The data receiver subsystem 500 may include a data definition file provider module 502, a confirmation receiver module 504, a source data access module 506, a formatting data removal module 508, and/or a transmission data provider module 510. Other modules may also be included.

The data definition file provider module 502 provides the data definition file 112 to a target (e.g., the client machine 102 and/or the provider 106). The confirmation receiver module 504 receives a conformation from the target of receipt of the data definition file.

The source data access module 506 accesses source data in a data format. The formatting data removal module 508 removes formatting data from the source data based on the data definition file 112 defining the data format to create transmission data.

The transmission data provider module 510 provides the transmission data to the target. The target may be capable of using the data definition file 112 to reconstruct the source data

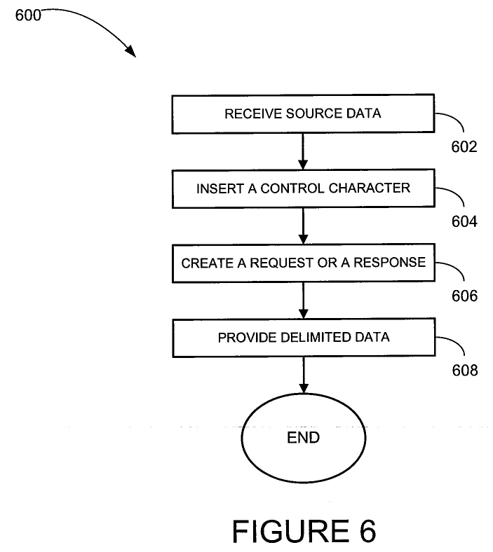

FIG. 6 illustrates a method 600 for delimited data providing according to an example embodiment. The method 600 may be performed by the client machine 102 and/or the provider 106 of the system 100 (see FIG. 1) or otherwise performed. The method 600 may be implemented by an application running on the client machine 102 and/or the provider 106, directly by the client machine 102 and/or the provider 106, or otherwise implemented.

Source data is received at block 602. A control character is inserted in the source data as a delimiter to create delimited data at block 604. The control character may be a nonprinting ASCII character. The control character may include a single control character or multiple control characters. The control character may be a character not used in normal language processing.

The delimiter may be a value delimiter, a dimension separator, an element delimiter, and/or an object delimiter. The delimiter may be a separator or an indicator. The delimiter may, in an example embodiment, represent dimensions in the source data. Other delimiters may also be used.

A request or a response may be created using the delimited data at block 606. In an example embodiment, the client machine 102 and/or the provider 106 may communicate with each other over the network 104 by sending a “request” and receiving a “response.” The request or the response may be a message that is self-sufficient capsule of information describing the purpose and containing the relevant information. The “request” and “response” may be created and transmitted through network logic.

The delimited data is provided over a network at block 608. The delimited text may be provided from a mobile device, to a mobile device, or otherwise provided. The delimited data may include delimited text or other types of delimited data. The providing of the delimited data may include providing the request or the response including the delimited data over the network.

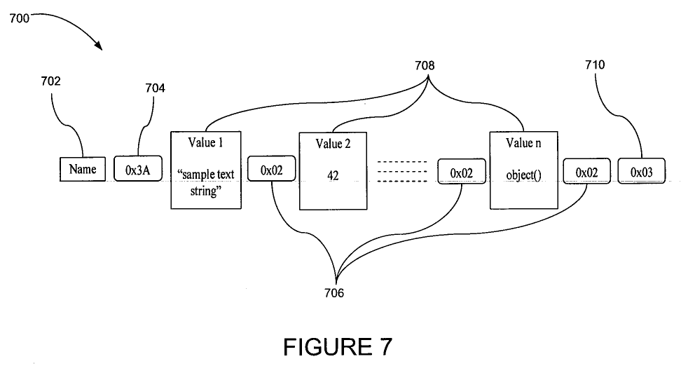

FIG. 7 illustrates an example element 700 according to an example embodiment. The element 700 may be a self-contained unit of data that may be used in various embodiments. A number of elements may act as basic building blocks of data and data description. In an example embodiment, an element may be created through core logic to contain a single item of information or an array of items. Each item may be any type of data including objects.

The parts of the element 700 include name data 706 and value data 708. The element 706 may contain a single name data 706 that describes the element and an unlimited amount of the value data 708. In an example embodiment, the name delimiter 702 may be a single colon (‘:’), represented by ASCII character hexadecimal: 0x3A. While the colon is a commonly used ASCII character, the name data 706 may be recognized from the value data 708 because the name delimiter 702 is only used as the first delimiter. In another embodiment, an escape sequence or a recognized combination of characters may be used as the name delimiter 702.

A value delimiter 704 may be used to separate multiple data values within the element 700. The value delimiter 704 may be inserted as the ‘STX’ character represented by ASCII character hexadecimal 0x02. Value delimiters 706 may be inserted in the data to separate each value. A value in an element may be any unit of data. For instance, the value may be a number or a string, for example, a line of text. The data may also be an object described below. For embodiment elements that are multidimensional, for example, a table with information organized into rows and columns, a dimension separator may be used in place of the value delimiter 704. The dimensions separator character may be the ‘EOT’ character represented by ASCII character hexadecimal 0x04. By inserting a dimension separator, an additional dimension may be interpreted when reading the data. When the 0x04 character is inserted between value items, an additional dimension may be created. By using a single ASCII character to delimitate values, the element 700 may contain a minimal amount of data overhead.

The last character of the element 700 may be the element delimiter 710 to punctuate the end of the element 700. The element delimiter 710 may enable identification of the end of the element 700. Other characters may also be used for delimitation.

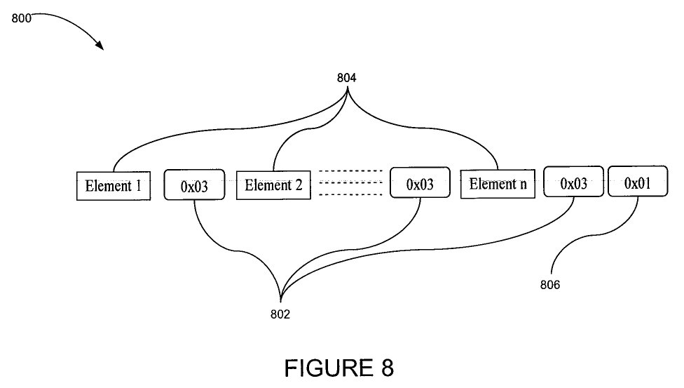

FIG. 8 illustrates an example object 800 according to an example embodiment. The object 800 may be a collection, or set, of various data elements 700 related to each other and treated as an individual entity. Like the elements 700, objects 800 are another type of basic building block of data. In an example embodiment, the objects 800 may serve as a collection of interrelated data.

The object 800 may include a series of elements 804 (e.g., a series of the elements 700 of FIG. 7) or any other series of delimited data. The data of the object 800 may be parsed using an element delimiter 802. The element delimiter 802 character may be the ‘ETX’ character represented by ASCII character hexadecimal 0x03. However, other characters may also be used. Like the elements 804, entire objects 800 may be concatenated in a similar manner as to the element 700 described above.

The object delimiter 806 may be the ‘SOH’ character represented by ASCII character hexadecimal 0x01. However, other characters may also be used. The last character of the object 800 may be the object delimiter 806 to punctuate the end of the object 800.

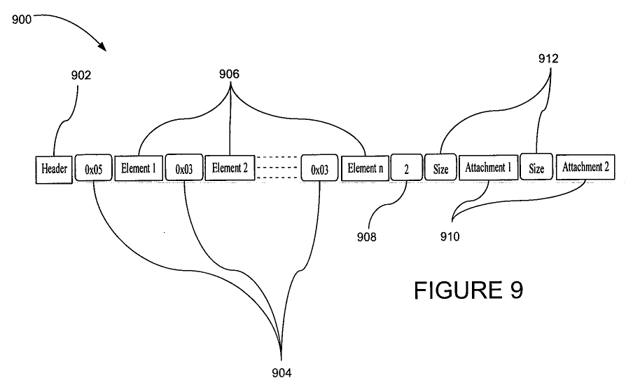

FIG. 9 illustrates an example message 900 according to an example embodiment. The message 900 may consist of a message header 902 and one or more elements in a body 904-910. The message 900 may be encoded and delimited 904 a manner similar to the element 700 and the object 800 (see FIGS. 7 and 8).

A message header 902 may contains one or more data items used for delivery including, by way of example, target, host information, application name, web service, and operation name. The message header 902 may be represented as a series of elements 906 with each element delimited with an element delimiter 904. The header delimiter character may be the ‘ACK’ character represented by ASCII character hexadecimal 0x05 may signal the end of header. However, other characters may also be used.

Messages 900 typically contain text based information but may also include binary data in addition to the text data. This binary data may be a picture, a video, or some other application specific data. The binary data may be appended to the message 900 without affecting the structure of the textual data, increasing parser complexity, or utilizing multiple network trips. The binary attachments may be concatenated to the end of the message data. For multiple attachments, each attachment may be delimited with a 32-bit number representing the size of the following attachment. In an example embodiment, the number may be larger or smaller, e.g. a 16-bit number depending on the requirements of the device's application. To assist processing, a binary indication may be a value as part of an element of the message 900.

The binary indicator may inform a processor of the message 900 to expect binary data in the attachment. In an example embodiment, the binary indication character may be the ‘VT’ character represented by ASCII character hexadecimal 0x0B. However, other characters may be used. In the case of multiple attachments to the message 900, the binary indicator may be coupled with an index number so that each attachment may be associated with its element. The index number may be a series of numbers starting with ‘0’; where ‘0’ represents the first attachment, and each successive attachment is the next increasing index number.

In additional to the information transferred in the message 900, additional units of data may be added to the message 900 in the form of the attachment 910. The attachment 910 may be a file associated with the message 900 and typically consists of documents, video, or images. To delimitate attachments 910 inside the message 900, a number of attachments 908 may be added after the last data item in the message 900. The number of attachments 908 may inform a processor that attachments are provided with the message 900. To separate two or more attachments, a file size 912 (e.g., as indicated by a 32-bit number) may be inserted before the attachments 910. The file size 912 may serve a dual function to delimitate the attachments 910, and to inform regarding the size of the attachment 910.

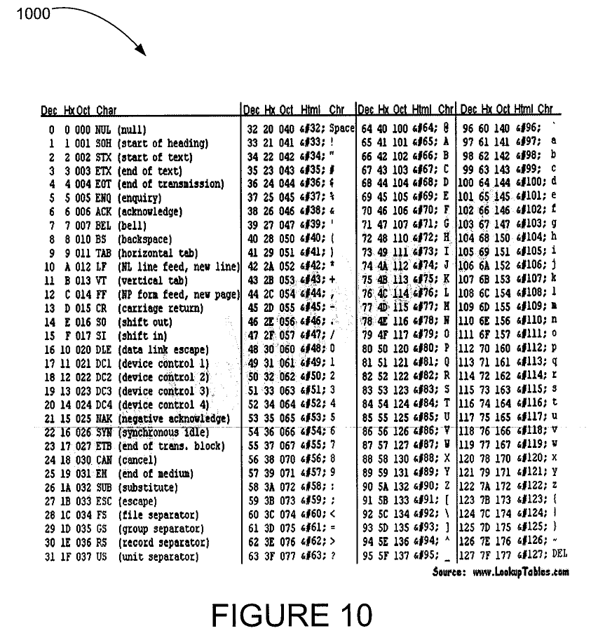

FIG. 10 is an example table 1000 of characters according to an example embodiment. While any character may be used for delimitation, so long as it may be recognized, in an example embodiment, specific obsolete American Standard Code for Information Interchange (ASCII) characters may be used. The ASCII characters in the example embodiment represent obsolete or seldom used characters in modern application. Because the characters are no longer in practical use and do not regularly appear in text or any other data, they may be more easily differentiated from the delimited data. The obsolete characters may be non-printing characters that do not appear as text, thus minimizing data collision.

The use of one or more obsolete ASCII characters as a control character may provide an advantage in data compatibility. The Unicode Standard is a widely used system of encoding data. Characters in the ASCII set are a subset to the Unicode Standard and have nearly identical code assignments; allowing easier adoption across a platform employing the Unicode Standard. Further, when only a single character is used per delimiter, the result is data that contains less extraneous organizational characters. The result is less data overhead and less total data to be processed.

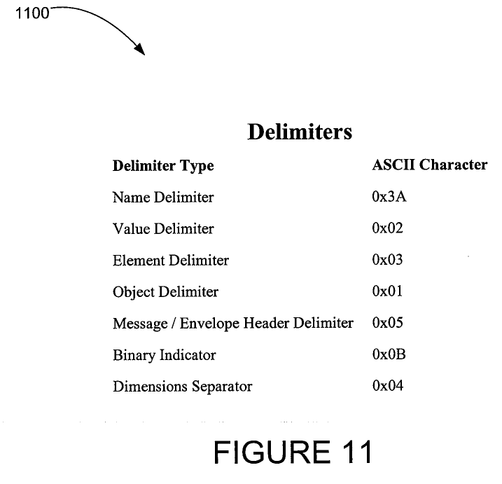

FIG. 11 is an example table 1100 of delimiters according to an example embodiment. The delimiters of the table 1100 may be used with the element 700, object 800, and message 900. However, other delimiters selected from the table 1000 or otherwise selected may also be used.

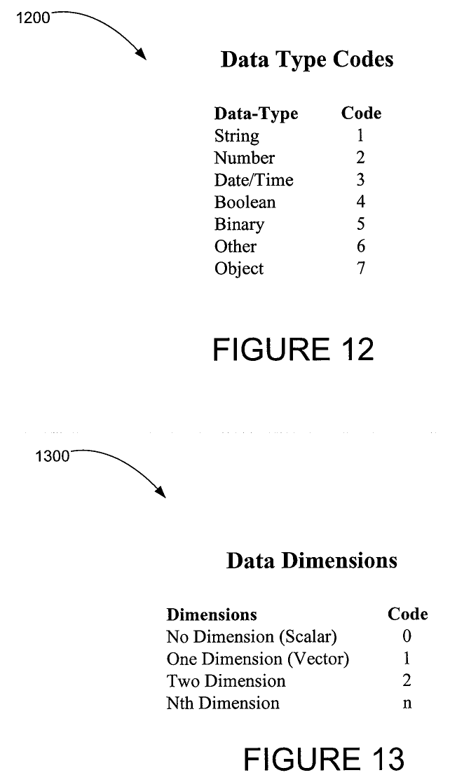

FIG. 12 is an example table 1200 of data type codes according to an example embodiment. The data codes may be used to provide a standard to enable transfer data with the codes. In an example embodiment, number ‘1’ may represent a string data type. Further data types may include Number, Date/Time, Boolean, Binary, Other, and Object with assigned codes ‘2’, ‘3’, ‘4’, ‘5’, ‘6’, and ‘7’ respectively. However, other data types and/or different codes may be used. The use of the data codes may minimize data overhead.

FIG. 13 is an example table 1300 of data dimensions according to an example embodiment. The data dimensions may be used to provide a standard to enable transfer data with the dimensions. In an example embodiment, the data dimensions may include Scalar (no dimension), Vector (one dimension), Two Dimension, and Three Dimension, may be assigned codes: ‘0’, ‘1’, ‘2’, and ‘3’, respectively. Subsequent dimensions may be assigned a code number equal to the number of dimensions. However, other dimensions and/or different codes may be used. The use of the data dimensions may minimize data overhead.

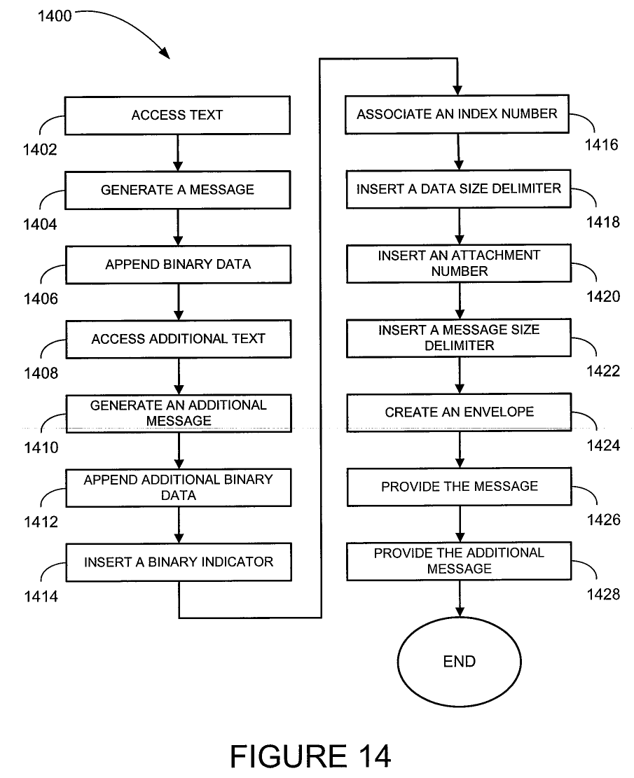

FIG. 14 illustrates a method 1400 for data appending according to an example embodiment. The method 1400 may be performed by the client machine 102 and/or the provider 106 of the system 100 (see FIG. 1) or otherwise performed. The method 1400 may be implemented by an application running on the client machine 102 and/or the provider 106, directly by the client machine 102 and/or the provider 106, or otherwise implemented.

Text may be accessed at block 1402. A message is generated from accessed text at block 1404.

Binary data is appended to the message as an attachment at block 1406. The binary data may include a digital image, a video clip, application specific data, or the like. Other types of binary data may also be appended.

Additional text may be accessed at block 1408. An additional message may be generated with the additional text at block 1410. Additional binary data may be appended to the additional message at block 1412.

A binary indicator may be inserted within the message to indicate a presence of the binary data within the message at block 1414.

An index number may be associated with the binary indicator to indicate a number of the attachment relative to an additional attachment at block 1416. A data size delimiter may be inserted within the message to indicate a data size of the binary data at block 1418.

At block 1420, an attachment number may be inserted within the message to indicate a number of attachments appended to the message. A message size delimiter may be inserted within the message to indicate a message size of the message at block 1422.

An envelope including the message appended with the binary data and an additional message appended with additional binary data may be created at block 1424.

The message appended with the binary data is provided over the network 104 to a recipient (e.g., the client machine 102 and/or the provider 106) at block 1426. The message appended with the binary data may be provided in a data stream over the network 104 to the recipient or otherwise provided.

The additional message appended with the additional binary data may be provided through the network to the recipient at block 1428. The message appended with the binary data and the additional message appended with the additional binary data may, in an example embodiment, provided in a single series through the network 104 to the recipient.

In an example embodiment, data transmission may be interrupted due to an inability to maintain a constant network connection. Because of the limited connection, it may be more efficient to transfer multiple messages in a single series rather than transferring each message individually.

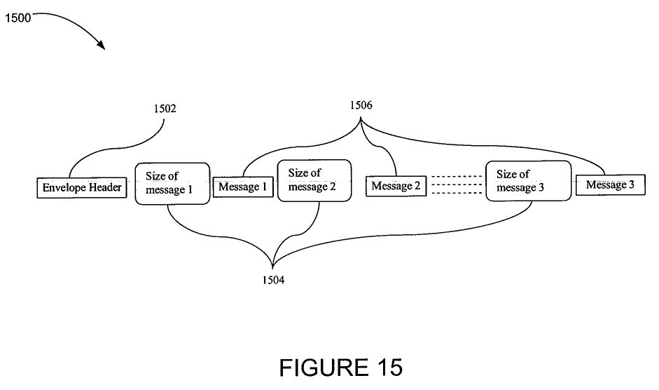

FIG. 15 illustrates an example envelope 1500 according to an example embodiment. The envelope 1500 contains multiple messages 1506. The series of messages 1506 may be delimited with a 32-bit number representing a size of the following message 1504. Similar to the message header 902 (see FIG. 9), the envelope 1500 may contain an envelope header 1502. The envelope header 1502 may, in an example embodiment, contain login information (e.g., user identification, password and client type). The login information may be delimited with the object delimiter 904 (see FIG. 9). Similar to the message 900 to delimitate attachments, the messages 1506 in the envelope 1500 may be delimited with a 16-bit or 32-bit integer representing the size of the message 1506 and index number. However, the messages may be delimited otherwise. Attachments for the messages 1506 may also be added to the envelope 1500.

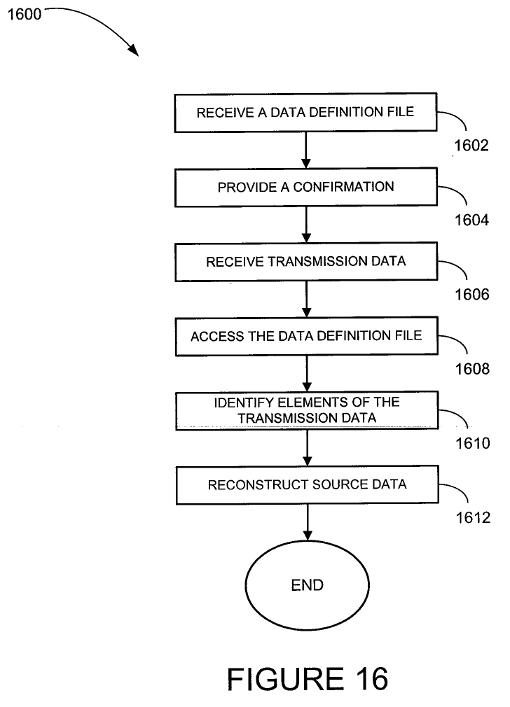

FIG. 16 illustrates a method 1600 for data receiving according to an example embodiment. The method 1600 may be performed by the client machine 102 and/or the provider 106 of the system 100 (see FIG. 1) or otherwise performed. The method 1600 may be implemented by an application running on the client machine 102 and/or the provider 106, directly by the client machine 102 and/or the provider 106, or otherwise implemented.

The data definition file 112 may be received (e.g., from the provider 106) at block 1602. A conformation of receipt of the data definition file 112 may be provided at block 1604.

Transmission data including a data type identifier is received at block 1606. The transmission data may include tagless transmission data or a different type of transmission data.

The data definition file 112 defining a data format for the transmission data based on the data type identifier is accessed at block 1608. Elements of the transmission data are identified based on the data definition file 112 at block 1610. At block 1612, the source data is reconstructed based on identification of the elements and the data definition file 112.

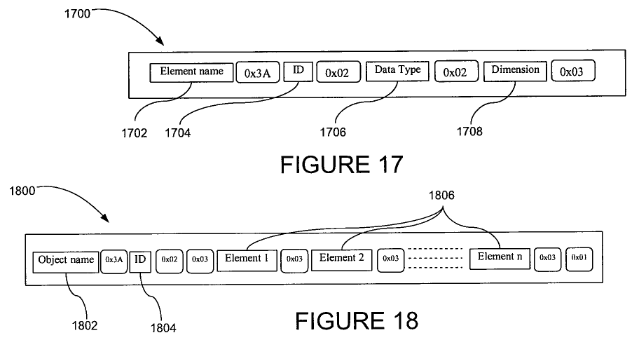

FIG. 17 illustrates an example element definition file 1700 according to an example embodiment. The data definition file 1700 may be deployed with the system 100 as the data definition file 112 (see FIG. 1) or may be otherwise deployed.

The element definition file 1700 is formatted in a manner similar to the aforementioned delineation method. For elements, the data definition file 1700 may indicate the element name 1702 is followed by the ID 1704. The ID 1704 may act as an index number to distinguish the element among a series of elements. The element name 1702 and the ID 1704 are separated by the name delimiter. After the ID 1704 may be the value delimiter 704 (see FIG. 7) followed by the data type 1706 (e.g., which may be a code from the table 1200 of FIG. 12) which may describe the value in an element defined by the element definition. Following the data type 1706 may be a dimension 1708. The dimension 1708 may be a code from table 1300 of FIG. 13 and may describe the size of the value.

FIG. 18 illustrates an example object definition file 1800 according to an example embodiment. The object definition file 1800 for objects may begin with an object name 1802 followed by a name delimiter and an object ID 1804. The object ID 1804 may be a number that acts as an index number for multiple objects. After the object ID 1804 may be a value delimiter and elements 1806. Each element 1806 may be an element definition as described above and may be separated by an element delimiter. The object definition may terminate with an element delimiter.

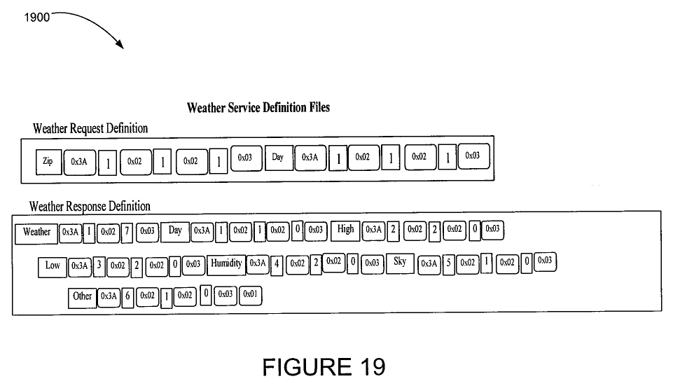

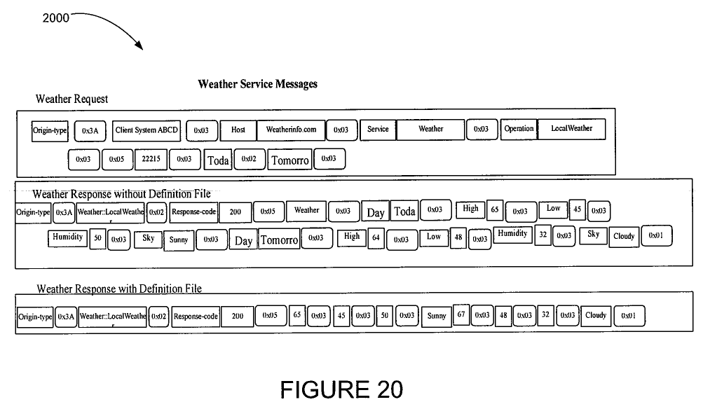

FIGS. 19 and 20 illustrate an example request definition file and response definition file 1900 and an example request and response 2000. The files 1900 and the request and response 2000 is an example embodiment of the use of the data definition files 1700, 1800 in accordance with various embodiments.

The client machine 102 (e.g., a mobile device) may send a request to the provider 106 (e.g., a server). The client machine 102 may format and delimitate the data using element and object delimiters. The request may contain information including origin type, host, and requested weather data. Values such as zip code and day of the week may be added to the request by the provider 106.

The request may begin with the origin type followed by the name delimiter and a description of the client machine 102. Following the description of the client machine 102 are a series of values each separated by the value delimiter 103. The values inform the provider 106 of the data the client machine 102 is requesting, including the location and type of data requested. Following the values is the element delimiter, and a series of objects to indicate the specific information requested. In the example the specific requested information is the weather for today and tomorrow in zip code: 22215. The request may be terminated with the element delimiter.

The provider 106 may create a response that indicates data including connection and weather data. Each element may conform to the data definition file. The response data is formatted and delimited to the specifications of the data definition file by the provider 106. In this example, the response begins with the origin-type of the server followed by the name delimiter and the provider name. Next may be a series of values including a response code. The response code may use the same codes as a Hypertext Transfer Protocols (HTTP) use for the World Wide Web. After the response code may be additional values separated by value delimiters. Each value may represent the requested information (e.g., the high and low temperature for the day). If the data definition file is not available, the response may include the names of each element (e.g., day, high, low, and sky). However, when the data definition file is used with the response, the element names may not be used by the client machine 102 to interpret the data that is formatted in the order predefined in the response data definition file. In the example embodiment, only the weather data may be included, without names to identify what the values are associated therewith. The ultimate result is a complete request and response containing a minimal amount of data overhead.

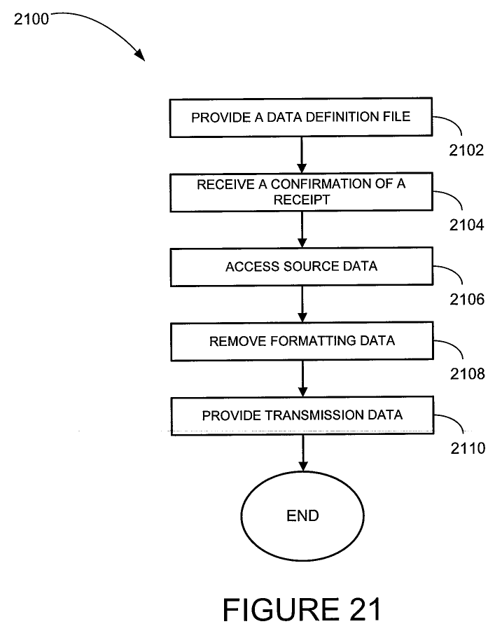

FIG. 21 illustrates a method 2100 for data providing according to an example embodiment. The method 2100 may be performed by the client machine 102 and/or the provider 106 of the system 100 (see FIG. 1) or otherwise performed. The method 2100 may be implemented by an application running on the client machine 102 and/or the provider 106, directly by the client machine 102 and/or the provider 106, or otherwise implemented.

The data definition file 112 may be provided to the target at block 2102. A conformation of receipt of the data definition file 112 may be received from a target (e.g., the client machine 102 and/or the provider 106) at block 2104.

Source data in a data format is accessed at block 2106. Formatting data is removed from the source data based on the data definition file 112 defining the data format to create transmission data at block 2108. The transmission data is provided to a target at block 2110.

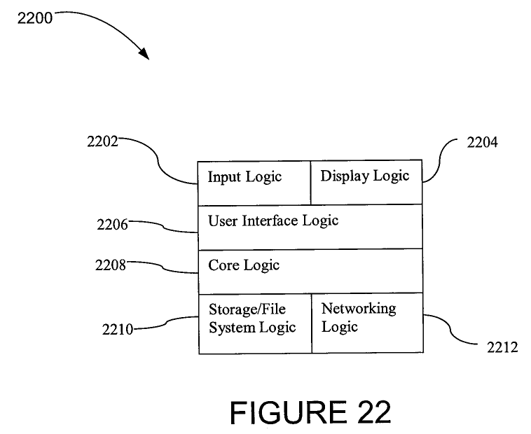

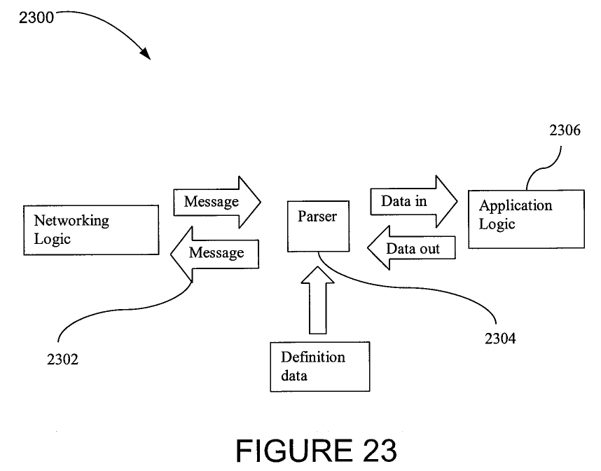

FIG. 22 illustrates example components 2200 of the client machine 102 and/or the provider 106 and FIG. 23 illustrates example flow logic 2300 of a message according to an example embodiment. The components 2200 may be capable of performing the discussed methods. The components 2200 may operate on a computer system to allow for user interaction. In an example embodiment, the components may be a part of an application that may manage different tasks.

Input logic 2202 may be responsible for interpreting user input. Display logic 2204 may be responsible for displaying data. The display logic 2204 may output data to the screen. User interface logic 2206 may allow the device to interpret interaction with the user. Core logic 2208 may include the basic components that are necessary for functionality. Storage/file system logic 2210 is responsible for storing data. The storage/file system logic 2210 allows for interaction with memory-type devices. Finally, networking logic 2212 may be included to allow for communication with other devices. Communication with other devices may include transferring data between a server and a client or between two like devices.

The components may interact with the network 104 and send messages 2302 through the networking logic 2212. The messages 2302 may be first processed according to the methods described by a parser 2304. The parser 2304 may take data from the application logic 2306 and insert encoded delimiter and other information. The parser 2304 also takes incoming messages 2302 and decodes and organizes the data so it may be passed to the application logic 2306. For example, the “request” and “response” created during the operations at block 606 (see FIG. 6) may be transmitted during the operations at block 608 through the applications networking logic 2216.

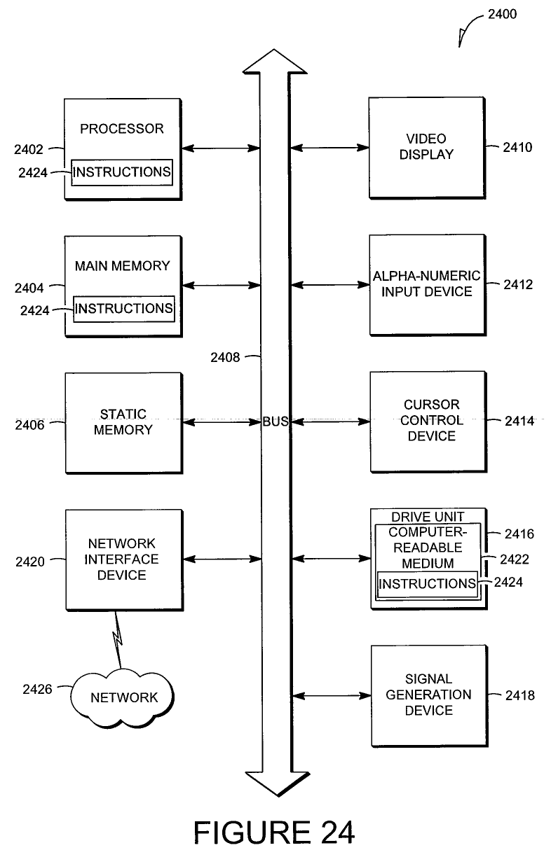

FIG. 24 shows a diagrammatic representation of machine in the example form of a computer system 2400 within which a set of instructions may be executed causing the machine to perform any one or more of the methods, processes, operations, or methodologies discussed herein. The provider 106 may operate on or more computer systems 2400. The client machine 102 may include the functionality of one or more computer systems 2400.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2400 includes a processor 2402 (e.g., a central processing unit (CPU) a graphics processing unit (GPU) or both), a main memory 2404 and a static memory 2406, which communicate with each other via a bus 2408. The computer system 2400 may further include a video display unit 2410 (e.g., a liquid crystal display (LCD) or a cathode ray tube (CRT)). The computer system 2400 also includes an alphanumeric input device 2412 (e.g., a keyboard), a cursor control device 2414 (e.g., a mouse), a drive unit 2416, a signal generation device 2418 (e.g., a speaker) and a network interface device 2420.

The drive unit 2416 includes a machine-readable medium 2422 on which is stored one or more sets of instructions (e.g., software 2424) embodying any one or more of the methodologies or functions described herein. The software 2424 may also reside, completely or at least partially, within the main memory 2404 and/or within the processor 2402 during execution thereof by the computer system 2400, the main memory 2404 and the processor 2402 also constituting machine-readable media.

The software 2424 may further be transmitted or received over a network 2426 via the network interface device 2420.

While the machine-readable medium 2422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the embodiments of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

In an example embodiment, the methods 600, 1400, 1600, 2100 may be applied to any application data, including file storage or data transfer. For example, mobile devices conventionally have limitations including low bandwidth, limited processing power, and discontinuous connection. Compact and efficient data transfer to and from mobile devices using one or more of the methods 600, 1400, 1600, 2100 may improve device performance and usability. The methods 600, 1400, 1600, 2100 may reduce data overhead and/or improved character processing.

Thus, methods and apparatuses for encoding data have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving source data;
inserting a control character in the source data as a delimiter to create delimited data; and
providing the delimited data over a network.

2. The method of claim 1, further comprising:
creating a request using the delimited data,
wherein the providing of the delimited data includes providing the request including the delimited data over the network.

3. The method of claim 1, further comprising:
creating a response using the delimited data,
wherein the providing of the delimited data includes providing the response including the delimited data over the network.

4. The method of claim 1, wherein the delimiter includes a value delimiter, a dimension separator, an element delimiter, an object delimiter, or combinations thereof.

5. The method of claim 1, wherein the control character is a nonprinting ASCII character.

6. The method of claim 1, wherein the delimiter is a separator or an indicator.

7. The method of claim 1, wherein the delimiter represents dimensions in the source data.

8. A method comprising:
generating a message from accessed text;
appending binary data to the message as an attachment; and
providing the message appended with the binary data over a network to a recipient.

9. The method of claim 8, further comprising:
inserting a data size delimiter within the message to indicate a data size of the binary data.

10. The method of claim 8, further comprising:
inserting an attachment number within the message to indicate a number of the attachments appended to the message.

11. The method of claim 8, further comprising:
inserting a binary indicator within the message to indicate a presence of the binary data within the message.

12. The method of claim 11, further comprising:
associating an index number with the binary indicator to indicate a number of the attachment relative to an additional attachment.

13. The method of claim 8, wherein the binary data includes a digital image, a video clip, application specific data, or combinations thereof.

14. The method of claim 8, further comprising:
creating an envelope including the message appended with the binary data and an additional message appended with additional binary data; and
providing the additional message appended with the additional binary data through the network to the recipient.
wherein the message appended with the binary data and the additional message appended with the additional binary data are provided in a single series through the network to the recipient.

15. The method of claim 14, further comprising:
inserting a message size delimiter within the message to indicate a message size of the message.

16. A method comprising:
receiving transmission data including a data type identifier
accessing a data definition file defining a data format for the transmission data based on the data type identifier;
identifying a plurality of elements of the transmission data based on the data definition file; and
reconstructing source data based on the identifying of the plurality of elements and the data definition file.

17. The method of claim 16, further comprising:
receiving the data definition file from the provider,
wherein the accessing of the data definition file is based on the receiving of the data definition file.

18. The method of claim 16, wherein the transmission data includes tagless transmission data.

19. A method comprising:
accessing source data in a data format;
removing formatting data from the source data based on a data definition file defining the data format to create transmission data; and
providing the transmission data to a target, the target capable of using the data definition file to reconstruct the source data.

20. The method of claim 19, further comprising:
providing the data definition file to the target.

21. The method of claim 20, further comprising:
receiving a conformation from the target of receipt of the data definition file,
wherein the removing of the formatting data is based on the receiving of the confirmation.

22. A machine-readable medium comprising instructions, which when implemented by one or more processors perform the following operations:
receive source data;
insert a control character in the source data as a delimiter to create delimited data; and
provide the delimited data over a network.

23. The machine-readable medium of claim 22, wherein the control character is a nonprinting ASCII character.

24. A system comprising:
a message generation module to generate a message from accessed text;
an appending module to appending binary data as an attachment to the message generated by the message generation module; and
a message provider module to provide the message generated by the message generation module appended with the binary data by the appending module over a network to a recipient.

25. The system of claim 24, further comprising:
a source data receiver module to receive source data; and
a control character insertion module to inserting a control character in the source data received by the source data receiver module as a delimiter to create the accessed text.

26. The system of claim 24, further comprising:
A formatting data removal module to remove formatting data from the accessed text based on a data definition file defining the data format to create transmission data,
wherein the message generation module generates the message with the transmission data.
